(19) United States
(12) Patent Application Publication
(10) Pub. No.: US 2007/0109120 A1
(43) Pub. Date: May 17, 2007

(54) Apparatus and method for preventing loss of a mobile telephone and for locating a lost mobile telephone

(76) Inventor: Guenter Schaefer, Coconut Creek, FL (US)

Correspondence Address: Ronald V. Davidge, Suite 219, 9900 Stirling Road, Cooper City, FL, 33024, US

(21) Appl. No.: 11/543,600

(22) Filed: Oct. 5, 2006

Related U.S. Application Data
(60) Provisional application No. 60/833,409, filed on Jul. 26, 2006.

(51) Int. Cl. G08B 1/08; G08B 21/00; B60R 25/10

(52) U.S. Cl. 340/539.23; 340/686.6; 340/426.1

(57) ABSTRACT

A system includes a mobile telephone, such as a cellular telephone, and a base unit that is formed as an article that is ordinarily worn by the user of the telephone. The telephone transmits a radio-frequency proximity signal that is received in the base unit, which sounds an alarm if the distance between the telephone and the base unit increases so that the proximity signal is not received. The base unit may also generate a radio-frequency signal causing the telephone to produce an audible signal so that it can be easily found.

This application claims the benefit of U.S. Provisional Application No. 60/833,409, filed Jul. 26, 2006.

### BACKGROUND OF THE INVENTION

1. Field of the Invention

This Invention relates to a mobile telephone, such as a cellular telephone, that is used with a base unit producing an alarm signal indicating relative movement causing the mobile telephone to be moved out of proximity with the base unit.

2. Background Information

Mobile phones come with many different designs and features. Some have games, some have a digital camera, and some can receive e-mail and some play music. There are just too many features to mention here. Since mobile phones are relatively small and light, they easily can be forgotten and misplaced. Besides the inconvenience caused by a forgotten mobile telephone, it also can become an expensive experience, as others are able to use the mobile telephone to their advantages.

The patent literature includes a number of descriptions of methods using radio signals for preventing the loss of items or for locating lost items. For example, U.S. Pat. App. Pub. No. 2005/0184150 A1 describes a system in which a piece of personal luggage containing a collection of items is provided with an RFID reader, while items within the collection are provided with RFID tags. The personal luggage may be a purse, wallet, backpack, brief case, etc. The RFID reader periodically polls the tags, expecting a given number of responses, corresponding to the number of tags ordinarily present in the luggage. If fewer responses are received, the reader issues a warning, such as a beeping sound.

U.S. Pat. No. 7,002,473 describes a system for preventing articles from becoming lost, misplaced or stolen, with the articles being tagged with, or with the articles otherwise containing an identifying device such as an RFID tag or a wireless network interface. The identifying device allows the articles to be monitored by a monitor, which periodically interrogates each identifying device with a transmitted RF signal, and which generates an alarm signal if an interrogated identifying device does not reply or is out of range. The identifying devices can be acquired by the monitor and associated with an alias that can be used to associate the identifying device with its associated article.

What is needed is a mobile telephone with an integrated ‘Forget Me Not’ feature that sounds automatically a signal when the owner gets too far away from the mobile telephone. Combined with this feature can also be a ‘Find Me’ sound that is manually activated, when the mobile telephone has been misplaced.

### SUMMARY OF THE INVENTION

According to the first aspect of the present invention, a system is provided comprising a mobile telephone and a base unit. The mobile telephone has a proximity signal transmitter transmitting a radio-frequency proximity signal. The base unit, which is formed as an article normally carried by a user of the mobile telephone, includes a proximity signal receiver and an alarm unit. The proximity signal receiver receives the radio-frequency proximity signal when the base unit is carried by the user with the mobile telephone additionally being carried by the user separately from the base unit. The alarm unit provides an alarm indication perceivable by the user when the mobile telephone is out of range for the radio-frequency proximity signal to be received by the proximity signal receiver.

In a first embodiment of the invention, the base unit causes an alarm, such as an audio signal, to be generated when the user leaves his mobile telephone at a location while walking away with carrying the base unit. In a second embodiment, this function is retained while providing an additional capability for aiding in the location of the mobile telephone when it is lost by causing the mobile telephone to ring or otherwise to produce an audible signal in response to the actuation of a switch within the base unit.

The base unit may be configured as a jewelry item having an elongated member configured to extend around a portion of the mobile telephone user's body, as a pendant to be attached to a key chain, or as a remote-control vehicle entry device.

According to various aspects of the invention, a mobile telephone may be built with integrated features serving conventional telephonic purposes and providing the loss detection and equipment finding capabilities of the invention, or a module may be added to provide additional loss detection and equipment finding capabilities to an existing conventional mobile telephone unit.

### BRIEF DESCRIPTION OF THE FIGURES

FIG. 1 is a block diagram of a system built in accordance with a first embodiment of the invention to include a base unit and a mobile telephone, with a radio-frequency proximity signal being transmitted from the mobile telephone to the base unit;

FIG. 2 is a block diagram of a system built in accordance with a second embodiment of the invention to include the elements of FIG. 1, with additional means to transmit a radio-frequency locating signal from the base unit to the mobile telephone;

FIG. 3 is block diagram of a first alternative version of the mobile telephone in FIG. 2, including a module used to retrofit a conventional mobile telephone unit;

FIG. 4 is a side elevation of a mobile telephone of FIG. 3; showing the module therein in an exploded relationship with the conventional telephone unit therein;

FIG. 5 is a rear elevation of the mobile telephone of FIG. 3;

FIG. 6 is a side elevation of a second alternative version of the mobile telephone in FIG. 2, including a rear access cover holding a module in an exploded relationship with a conventional telephone unit therein;

FIG. 7 is a pictographic view of a version of the system of FIG. 2 with a base unit therein formed as a jewelry item;

FIG. 8 is a pictographic view of a version of the system of FIG. 2 with a base unit therein formed as a pendant attached to a key chain;

FIG. 9 is a pictographic view of a version of the system of FIG. 2 with a base unit therein formed as a vehicle entry remote control device

FIG. 10 is a pictographic view of a version of the system of FIG. 2 with a base unit therein formed as a wristwatch.

### DETAILED DESCRIPTION OF THE INVENTION

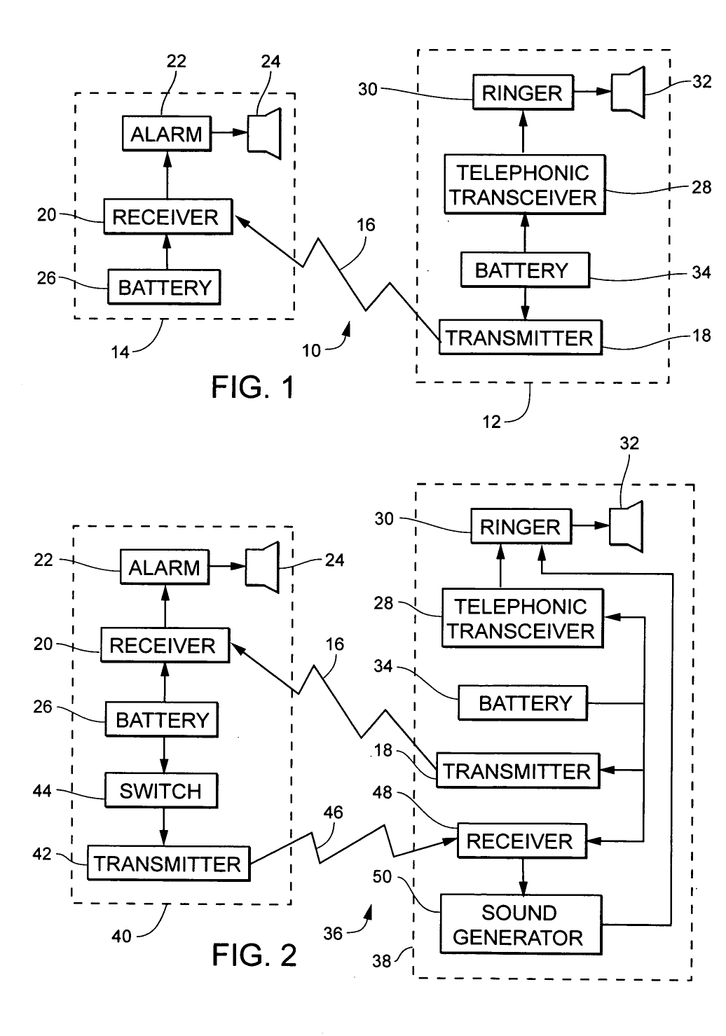

FIG. 1 is a block diagram of a system 10 configured in accordance with a first embodiment of the invention to include a mobile telephone 12, which is, for example, a cellular telephone, and a base unit 14, together with means to establish a radio-link with a radio-frequency proximity signal 16 between a transmitter 18 within the mobile telephone 12 and a receiver 20 within the base unit 14. The base unit 14, which is formed as an article that is normally carried by a user of the mobile telephone 12, further includes an alarm unit 22 producing an signal perceptible to the user when the user when the radio-link is broken by moving the mobile telephone 12 or the base unit 14 so that the receiver 20 within the base unit 14 is out of range to receive the radio-frequency proximity signal 16 from the transmitter 18 within the mobile telephone unit 12. For example, when the radio-link is broken, the alarm unit 22 drives a speaker 24 to produce an audible sound. A battery 26 within the base unit 14 provides power for the receiver 20, and through the receiver 20, for the alarm unit 22.

The mobile telephone 12 includes conventional elements, such as a telephonic transceiver 28 for sending and receiving telephone calls, a ringer 30, which causes ring tones to be produced through a speaker 32 in response to an input signal from the telephonic transceiver 28, and a battery 34, which provides power for the telephonic transceiver 28, for the transmitter 18, and, through the telephonic transceiver 28, for the ringer 30.

Because the base unit 14 is formed as an article that is normally carried by the individual using the mobile telephone 12, the radio link formed by the radio-frequency proximity signal 16 is maintained during normal use of the mobile telephone. However, if the mobile telephone 12 is left behind, or if it is carried away by someone else without the base unit 14, a perceptible alarm signal is formed, such as an audio signal through the speaker 24, so that the user of the mobile telephone 12, remaining in possession of the base unit 14 knows that the mobile telephone 12 is missing.

FIG. 2 is a block diagram of a system 36 configured in accordance with a second version of the invention to include a mobile telephone 38 and a base unit 40. The system 36 is configured in accordance with a second embodiment of the invention to include the elements of the system 10, which are accorded like reference numerals, together with additional elements used to facilitate locating the mobile telephone 38 in the event that the mobile telephone 38 is lost.

Specifically, the base unit 40 additionally includes a transmitter 42, which is powered by the battery 26 through a switch 44, so that a radio-frequency locating signal 46 is transmitted whenever the switch 44 is actuated. The mobile telephone 38 additionally includes a receiver 48 for receiving the radio-frequency locating signal 46 and a sound generator 50 causing an audible sound to be produced whenever the radio-frequency locating signal 46 is received by the receiver 48. For example, the sound generator 50 causes the ringer 28 to drive the speaker 30, so that an audible sound is produced. The battery 34 additionally provides power for the receiver 48 and, through the receiver 48, for the sound generator 50.

The mobile telephone 12 of FIG. 1 and the mobile telephone 38 of FIG. 2 are integrated devices, in which at least some circuits are used in both the apparatus for notifying the user of the loss of the mobile telephone and in the telephonic apparatus. For example, the battery 34 is used both to provide power for the telephonic transceiver 28 and to the transmitter 18 in both mobile telephones 12, 38, and additionally to the receiver 48 in the mobile telephone 38. This configuration provides a particular advantage, in that, whenever the battery is recharged, it is made available for continued use with the apparatus for notifying the user of the loss of the mobile telephone as well as for the operation of conventional telephonic processes. In the mobile telephone 38 of FIG. 2, circuits within the sound generator 50 and the telephonic transducer 28 are additionally integrated with one another to drive a common ringer 30, which is therefore used both to provide an indication of an incoming telephone call and of an attempt to find the mobile telephone 38 by actuating the switch 44 within the base unit 40. Therefore, according to preferred versions of the invention, mobile telephones built to include features to facilitate the detection of a lost mobile telephone and/or to facilitate finding such a telephone are configured as described in reference to FIG. 1 or FIG. 2.

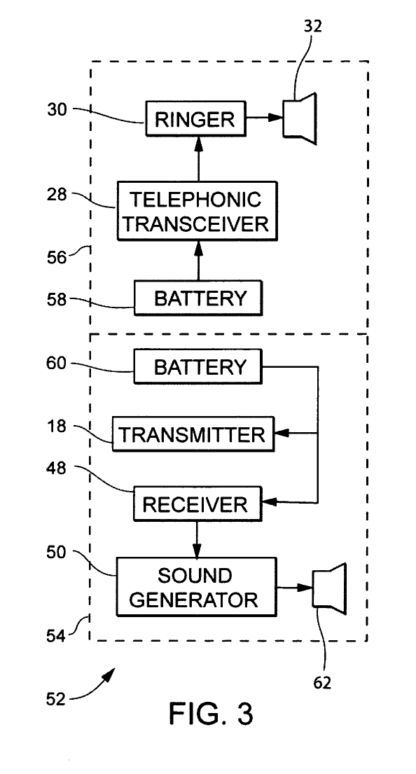

While such telephones may be built as new devices by original equipment manufacturers of mobile telephones, devices built in accordance with additional variations of the invention may be used to update vast numbers of telephones not equipped to provide the features of this invention. Such devices for updating conventional mobile telephone units will now be discussed in reference to FIGS. 3-6.

FIG. 3 is a block diagram of a mobile telephone 52 built as an first alternative version of the mobile telephone 38 shown in FIG. 2, with a module 54 being provided for attachment to an otherwise conventional mobile telephone unit 56. The mobile telephone 52 includes a number of elements in common with the mobile telephone 36, which have been discussed above in reference to FIGS. 1 and 2, and which are therefore accorded like reference numerals. However, in the example of FIG. 3, the circuits within the module 54 and the conventional mobile telephone unit 56 are separately configured, with a first battery 58 providing power within the telephone unit 56, and with a second battery 60 providing power within the module 54. Furthermore, the sound generator 50 produces an audible signal in response to an output from the receiver 50 by driving a separate speaker 62 within the module 52. Preferably, the module 54 is distributed, together with the base unit 40, for upgrading a number of different types of conventional mobile telephone units.

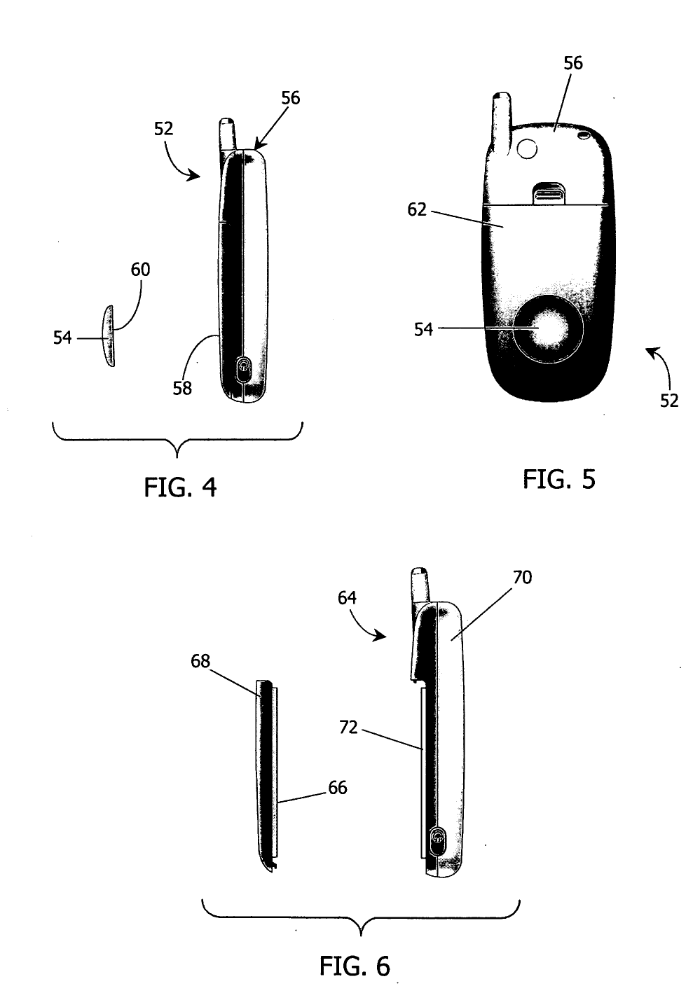

FIG. 4 is a side elevation of the mobile telephone 52, showing the module 54 in an exploded relationship with the conventional mobile telephone unit 56. For example, the module 54 is attached to an external surface 58 of the conventional mobile telephone unit 56 by means of a pressure sensitive adhesive coating on an external surface 60 of the module 54.

FIG. 5 is a rear elevation of the mobile telephone 52, showing the module 54 attached to a rear access cover 62 of the conventional mobile telephone unit 56.

FIG. 6 is a side elevation of a mobile telephone 64 built as a second alternative version of the mobile telephone 38 shown in FIG. 2, with a module 66, including all of the elements within the module 54 (shown in FIG. 3), except for the second battery 60, being held in a rear access cover 68. The rear access cover 68 is shown in an exploded relationship with a remaining portion of a conventional telephone unit 70. A single battery 72, extending between the module 66 and circuits within the conventional mobile telephone unit 70, is electrically connected to provide power both for the circuits within the conventional mobile telephone unit 70 and the module 66, so that the advantage of recharging a battery for both uses is maintained. Preferably, various versions of the rear access cover 68, as required to fit various types of conventional telephone units 70, are distributed with the base units 40 and the modules 54 to upgrade conventional telephone units 70. A new battery 72 may also be included to provide electrical connections for both the module 66 and for circuits within the conventional telephone unit 70.

While the preceding discussion in reference to FIGS. 3-6 has been directed at retrofitting a conventional mobile telephone unit to take the place of the mobile telephone 38 in the system 36 of FIG. 2, it is understood that similar methods can readily be employed to retrofit a conventional mobile unit to take the place of the mobile telephone 12 in FIG. 1, by using a module similar to the module 54 of FIGS. 3-5, or similar to the module 66 of FIG. 6, except that, in either case, the receiver 48, sound generator 50, and speaker 62 would be eliminated.

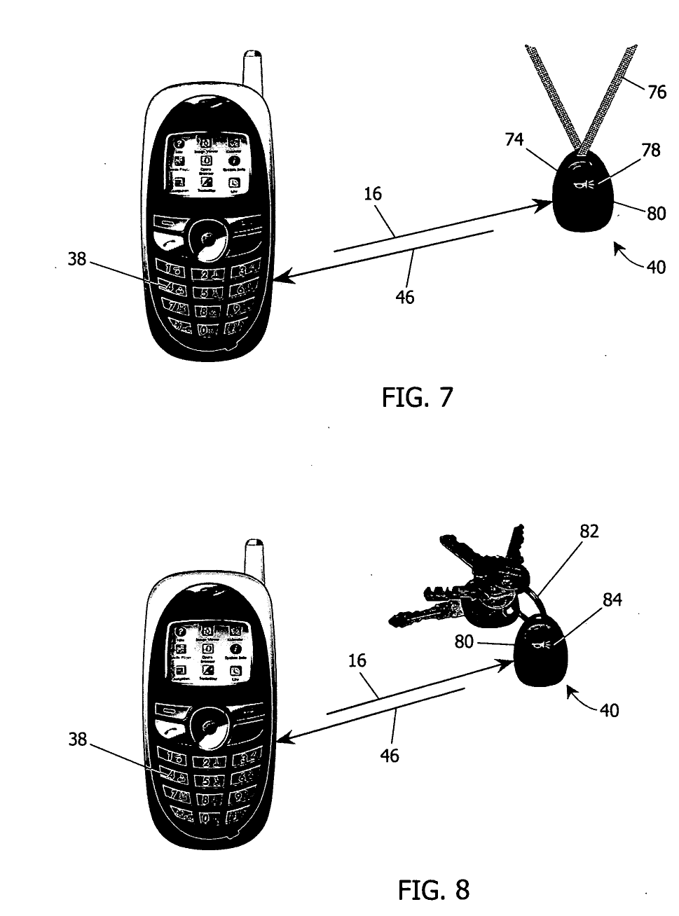

Alternative versions of the base unit 40 will now be discussed, with reference being made to FIGS. 7-9 each of which is a pictographic view of the system 36 having a different version of the base unit 40.

As shown In FIG. 7, the base unit 40 is formed as a jewelry item 74 having an elongated member 76, such as a band or chain, formed to extend around a portion of the user's body, for example, as a bracelet or necklace, and additionally including a button 78 that is depressed to actuate the switch 44 (shown in FIG. 2). As shown in FIG. 8, the base unit 40 is formed as a pendant 80 attached to a keychain 82, having a button 84 that is used to actuate the switch 44. As shown in FIGS. 7 and 8, the base unit 40 includes a pendant 80 having a hole 86 for attachment to either an elongated member 76, formed to extend around a portion of the user's body, or a keychain 82.

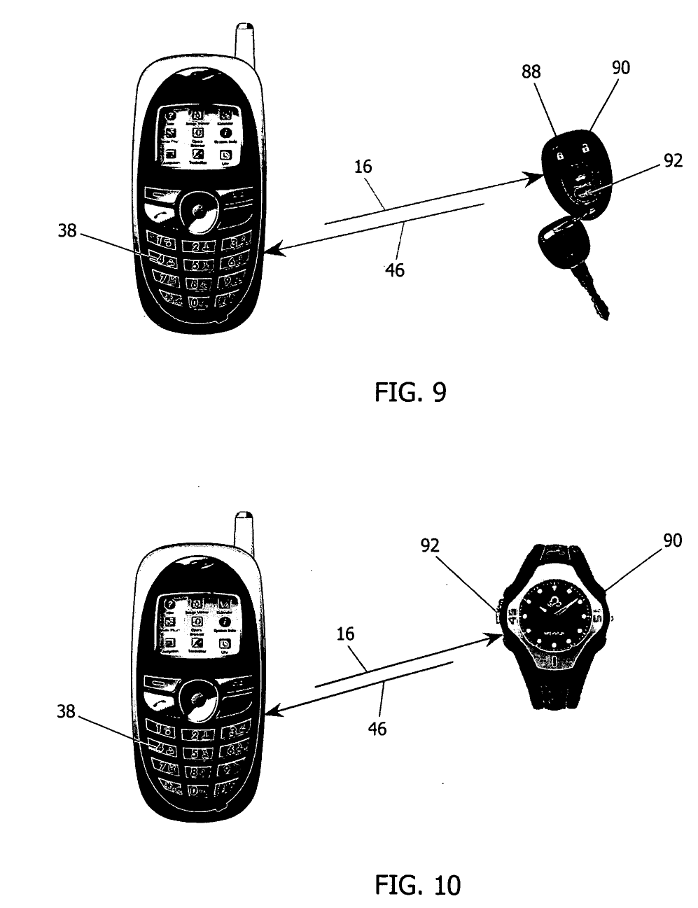

As shown in FIG. 9, the base unit 40 is alternately formed as a remote control device 88 for vehicle entry, used to transmit a radio-frequency signal for vehicle entry in response to depression of a button 90, with a battery powering the device 88 for vehicle entry also being used to power the transmitter 42 and receiver 20 (shown in FIG. 2), and with a button 92 also being provided to actuate the switch 44.

As shown in FIG. 10, the base unit 40 is alternately formed as a wristwatch 90 having a button 92 provided to actuate the switch 44, and with a battery powering the wristwatch 90 to provide timekeeping also being used to power the transmitter 42 and receiver 20.

Bi-directional radio-frequency communications between each of the access devices, in the form of a proximity signal 16, and in the form of a locating signal 46 are established between each of the base units 40 of FIGS. 7-9 and a mobile telephone unit 28, in accordance with the second embodiment of the invention, as described above in reference to FIG. 2. It is additionally understood, that a base unit 14 formed as described in reference to each of the FIGS. 7-9 can be used in a system built, as described above in reference to FIG. 1, in accordance with the first embodiment of the invention, with radio-communications being established between the mobile telephone 12 and the base unit 14, and with the buttons 78, 84, 90, described as being used for actuation of the switch 44, being eliminated.

In either embodiment of the invention, the radio-frequency proximity signal 16 is preferably composed of a series of pulses transmitted on a periodic basis to save battery energy, with the receiver 20 being configured to cause operation of the alarm unit 22 when a predetermined number of the pulses have not been received, as indicated by the passage of time without receiving a pulse. The radio-frequency proximity signal 16 may be encoded so that the receiver 20 can recognize a mobile telephone 12, 38 with which it is associated even in a room full of such mobile telephones 12, 38. Such encoding may include varying the frequency at which the signal 16 is transmitted or varying the pattern, such as the width, of pulses transmitted. In the second embodiment of the invention, the locating signal may be similarly encoded, so that a particular mobile telephone 38 can be found in a room full of mobile telephones 38.

While the invention has been described in its preferred forms or embodiments with some degree of particularity, it is understood that this description has been given only by way of example, and that many variations can be produced without departing from the spirit and scope of the invention, as described in the appended claims.

What is claimed is:

1. A system comprising;
a mobile telephone having a proximity signal transmitter transmitting a radio-frequency proximity signal;
a base unit, formed as an article normally carried by a user of the mobile telephone, including a proximity signal receiver, and an alarm unit, wherein the proximity signal receiver receives the radio-frequency proximity signal when the base unit is carried by the user with the mobile telephone additionally being carried by the user separately from the base unit, and wherein the alarm unit provides a perceivable alarm indication when the mobile telephone is out of range for the radio-frequency proximity signal to be received by the proximity signal receiver.

2. The system of claim 1, wherein
the base unit is formed as a pendant including a hole for attachment to a key ring or to an elongated jewelry member for wearing, and
the base unit additionally includes a battery powering the proximity signal receiver and the alarm unit.

3. The system of claim 1, wherein
the base unit is formed as a remote control device for vehicle entry, and
the base unit additionally includes a vehicle entry transmitter generating and transmitting a vehicle entry signal and a battery powering the vehicle entry transmitter, the proximity signal receiver, and the alarm unit.

4. The system of claim 1, wherein the mobile telephone includes a telephonic transceiver and a battery powering both the telephonic transceiver and the proximity signal transmitter.

5. The system of claim 1, wherein the mobile telephone additionally includes:
an access cover removable for battery replacement, and
a module held within the access cover including the proximity signal transmitter.

6. The system of claim 1, wherein the mobile telephone additionally includes;
an external housing surface, and
a module attached to the external housing surface holding the proximity signal transmitter and a battery powering the proximity signal transmitter.

7. The system of claim 1, wherein
the base unit additionally includes a switch and a locating signal transmitter transmitting a radio-frequency locating signal in response to actuation of the switch,
the mobile telephone additionally includes a locating signal receiver receiving the radio-frequency locating signal and a sound generator producing an audible sound in response to receiving the radio-frequency locating signal.

8. The system of claim 7, wherein the mobile telephone additionally includes
a telephonic transceiver;
a ringer operating in response to receiving a signal from the telephonic transceiver and additionally in response to receiving a signal from the sound generator, and
a battery powering the telephonic transceiver, the ringer, the proximity signal transmitter, the locating signal receiver, and the sound generator.

9. The system of claim 7, wherein the mobile telephone additionally includes:
an external housing surface, and
a module attached to the external housing surface holding the proximity signal transmitter, the locating signal receiver, the sound generator, and a battery powering the proximity signal transmitter, the locating signal receiver, and the sound generator.

10. The system of claim 7, wherein
the base unit is formed as a pendant including a hole for attachment to a key ring or to an elongated jewelry member for wearing and a pushbutton actuating the switch, and
the base unit additionally includes a battery powering the proximity signal receiver, the alarm unit, and the locating signal transmitter.

11. The system of claim 7, wherein
the base unit is formed as a remote control device transmitting a radio-frequency signal for vehicle entry, and
the base unit includes a battery powering transmission of the radio-frequency signal for vehicle entry, the proximity signal receiver, the alarm unit, and the locating signal transmitter.

12. The system of claim 1, wherein
the radio-frequency proximity signal comprises pulses transmitted periodically, and
the alarm unit is activated to provide a perceivable alarm when the proximity signal receiver fails to receive a predetermined number of the pulses of the radio-frequency proximity signal.

13. The system of claim 1, wherein
the radio-frequency proximity signal is encoded to produce a signal individually recognizable among a number of mobile telephones producing radio-frequency proximity signals,
the base unit is configured to recognize the radio-frequency proximity signal among a number of mobile telephones producing radio-frequency proximity signals.

14. The system of claim 13, wherein the radio-frequency proximity signal is encoded by modulating a carrier wave having a frequency associated with the mobile telephone and with the base unit.

15. The system of claim 13, wherein
the radio-frequency proximity signal comprises pulses transmitted periodically, and
each of the pulses has a pattern associated with the mobile telephone and with the base unit.

16. The system of claim 1, wherein
the base unit is formed as a wristwatch, and
the base unit additionally includes a battery powering a timekeeping function of the wristwatch, the proximity signal receiver, and the alarm unit.

17. A module comprising:
a surface attachable to an external surface of a mobile telephone,
a proximity signal transmitter transmitting a radio-frequency proximity signal, and
a battery powering the location signal transmitter.

18. The module of claim 17, additionally comprising a locating signal receiver receiving the radio-frequency locating signal and a sound generator producing an audible sound in response to receiving the radio-frequency locating signal, wherein the battery additionally powers the locating signal receiver and the sound generator.

19. Apparatus comprising:
an access cover attachable to a mobile telephone,
a proximity signal transmitter transmitting a radio-frequency proximity signal, and
an electrical connection for attaching the proximity signal transmitter to a battery within the mobile telephone.

20. The apparatus of claim 19, additionally comprising a locating signal receiver receiving the radio-frequency locating signal and a sound generator producing an audible sound in response to receiving the radio-frequency locating signal, wherein the electrical connection additionally attaches the locating signal receiver and the sound generator to the battery within the mobile telephone.
